(19) United States
(12) Patent Application Publication
(10) Pub. No.: US 2016/0155190 A1
(43) Pub. Date: Jun. 2, 2016

(54) METHOD FOR MODIFYING A LOAN AGAINST PROPERTY THAT EMBODIES NEGATIVE EQUITY

(71) Applicant: Christopher Baker, San Bernardino, CA (US)

(72) Inventor: Christopher Baker, San Bernardino, CA (US)

(21) Appl. No.: 14/555,629

(22) Filed: Nov. 27, 2014

(51) Int. Cl. G06Q 40/02

(52) U.S. Cl. CPC G06Q 40/025

(57) ABSTRACT

In one preferred embodiment of the invention, the method for modifying a loan against property that embodies negative equity includes: identifying a summation of current outstanding monies owed by a borrower(s) of a loan, identifying the current value of the property against which a loan has been originated, determining whether the summation of outstanding monies owed is greater than the current value of the property, identifying whether there is mutual desire between a loan borrower(s) and lender to forgive a quantity of the summation of outstanding monies owed, determining the timing and terms under which a quantity of outstanding monies owed by the borrower(s) may be forgiven, and executing the forgiveness.

### CROSS-REFERENCE TO RELATED APPLICATIONS

None.

### TECHNICAL FIELD

This invention relates generally to the financial field, and more specifically to a new and useful method of modifying a loan against property that embodies negative equity.

### BACKGROUND

A property embodies negative equity when the current summation of outstanding monies due in accordance with a loan against that property is greater than the current value of the property itself. In common parlance, this is also known as a property being “underwater.” The rate at which borrowers default on loans originated against property when that property embodies negative equity is troubling. The consequences of such default are severe for the borrower, the lender, and even nearby property owners, and the financial impact can last well into the future. Thus, there is a need in the financial field to create a new and useful method for modifying a loan against property that embodies negative equity to reduce the occurrence of intentional default. This invention provides such a new and useful method.

### BRIEF DESCRIPTION OF THE FIGURES

FIG. 1 is a flowchart of the preferred embodiment of the invention.

### DETAILED DESCRIPTION OF THE EMBODIMENTS OF THE INVENTION

The following description of the preferred embodiments of the invention is not intended to limit the invention to these preferred embodiments, but rather to enable any person skilled in the art to make and use this invention.

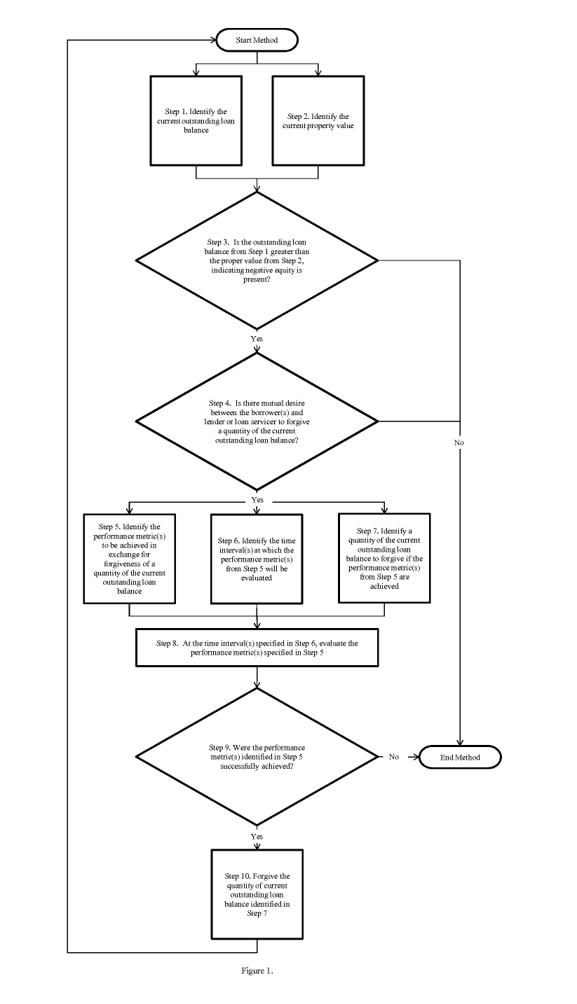

As mentioned above and shown in the numbered Steps of FIG. 1 that correlate to the numbered paragraphs below, the method for modifying a loan that may or may not be secured by a lien in any position against real, intellectual, tangible, intangible, or any other property, when said property embodies negative equity preferably includes determining the quantity, timing, and conditions under which a quantity of outstanding monies due from and owed by one or more borrower(s) may be forgiven when there is mutual desire to do so between the borrower(s) and the lender, the loan servicer managing the administration of the loan through delegated or non delegated authority, or any parties with an interest related to the lent monies as well as the terms under which this method shall terminate.

### 1. Identify the Current Outstanding Loan Balance

The current outstanding loan balance is the total current sum of money due from and owed by the borrower(s) of the loan to the lender or loan servicer managing the administration of the loan at the time in which the method contained herewith is applied. This balance includes, but is not limited to, the current: unpaid principal loan balance; any accrued or delinquent loan interest or escrow monies or shortages; late fees; corporate advances or recoverable fees; prepaid monies expended by the lender or loan servicer for the benefit of the borrower(s); annual or account fees; non sufficient fund or returned fund fees; servicing or loan processing fees; pre-payment or other penalties; property inspection or valuation fees; third party fees from entities that may include, but are not limited to, attorneys, title companies, insurance companies, publication services, rating agencies; or any other fees, expenses, or costs that are due from and owed by the borrower(s) of the loan to the lender or loan servicer managing the administration of the loan; or any combination thereof.

### 2. Identify the Current Property Value

The current property value is an opinion of value established through a valuation method that is acceptable to, and utilized by, the lender or loan servicer managing the administration of the loan at the time in which the method contained herewith is applied. The value may be established through such methods including, but not limited to, a: property appraisal, which may or may not adhere to property appraisal guidelines set forth by a local, regional, state, or national oversight board; property broker price opinion; comparative market or comparable sales analyses; an automated valuation model; proprietary valuation models; or any other method of valuation deemed acceptable to, and utilized by, the lender or servicer.

3. Identify Whether the Outstanding Loan Balance from Step 1 is Greater than the Property Value from Step 2, Indicating Said Property Embodies a Quantity of Negative Equity

The property embodies negative equity if the current outstanding loan balance from Step 1 is greater than the current property value from Step 2 at the time in which the method contained herewith is applied. The specific quantity of negative equity embodied by the property is calculated as the mathematical difference between these values: the current property value from Step 2 minus the current outstanding loan balance from Step 1, whereby the resulting figure is negative. When negative equity is present, the user of this method shall proceed to Step 4. If the current property value from Step 2 is greater than the current outstanding loan balance from Step 1 at the time this method is applied, then the property does not embody negative equity and this method terminates since it applies only when said property embodies negative equity, as shown by the “End Method” flowchart terminator.

4. Identify Whether there is Mutual Desire Between the Borrower(s) and the Lender or Loan Servicer Managing the Administration of the Loan to Forgive a Quantity of the Current Outstanding Loan Balance

If there is mutual desire between the borrower(s) and the lender, the servicer managing the administration of the loan, or any other parties with an interest related to the lent monies to forgive a quantity of the current outstanding loan balance at the time this method is applied, then the user of this method shall proceed to Step 5. The parties related to the lender, the loan servicer managing the administration of the loan, or to the lent monies may include, but are not limited to, an: investor or pool of investors; a trust, trustee, or trust administrator; an insurer; a securities depositor or issuer; a guarantor; an arranger; an asset manager; or any other related entity. In the event that there is not said mutual desire between the borrower(s) and the lender, the loan servicer administering the loan, or other parties related to the lent monies to forgive a quantity of the current outstanding loan balance, then this method terminates since its continued application requires said mutual desire, as shown by the “End Method” flowchart terminator.

### 5. Identify the Performance Metric(s) for the Borrower(s) to Achieve in Exchange for Forgiveness of a Quantity of the Current Outstanding Loan Balance

The lender or servicer managing the administration of the loan specifies one or more performance metrics, conditions, requirements, or other terms which must be successfully achieved by the borrower(s) in exchange for forgiveness of a quantity of the current outstanding loan balance. Said metrics, conditions, requirements, or other terms may include, but are not limited to, the current or future payment of full or partial on time periodic loan installment payments. Said metrics, conditions, requirements, or other terms may include, but are not limited to, the payment of additional funds different from a full or partial periodic installment payment that may be applied to the: current principal balance; accrued or delinquent loan interest or escrow monies or shortages; late fees; corporate advances or recoverable fees; prepaid monies expended by the loan servicer for the benefit of the borrower(s); annual or account fees; non sufficient fund or returned fund fees; servicing or loan processing fees; pre-payment or other penalties; property inspection or valuation fees; or third party fees related to the administration or delinquency of the loan. Said metrics, conditions, requirements, or other terms may also include, but are not limited to, a: calculation or attainment of a specific value or range of values of the modified loan with or without any combination of the capitalization of the aforementioned outstanding monies; or a calculation or attainment of a specific value or range of values for the comparative net value between the modified loan versus the unmodified loan either with or without any combination of the capitalization of the aforementioned outstanding monies, such as a net present value or any other value calculation. Said metrics, conditions, requirements, or other terms may also include, but are not limited to, the creation of new terms: account or loan fees; pre-payment penalties or other fees, costs, or expenses payable by the borrower(s); or any other fees that may be due and payable at the time of creation, capitalized into the outstanding loan balance, or due at some future time based on additional specific metrics, conditions, requirements, or other terms. Said metrics, conditions, requirements, or other terms may also include, but are not limited to, the future avoidance of: late fees; delinquent loan interest or escrow monies or shortages; corporate advances or recoverable fees; prepaid monies expended by the lender or loan servicer for the benefit of the borrower(s); non sufficient fund or returned fund fees; pre-payment or other penalties; third party fees related to the administration or delinquency of the loan; or any other fees, costs, or expenses associated with late or incomplete payments or any other delinquency. Said metrics, conditions, requirements, or other terms may also include, but are not limited to, referral to any stage of a loss mitigation process or program including, but not limited to, referral to foreclosure, repossession, or any other loss mitigation or liquidation options. Said performance metric(s,) conditions, requirements, or other terms may also include, but are not limited to, any combination of the aforementioned: current, future, future avoidance, newly created or any other performance metrics, conditions, requirements, or terms specified by the lender or servicer managing the administration of the loan either in whole or in part.

6. Identify the Time Interval(s) During, at, or by which the Performance Metric(s) from Step 5 Will be Evaluated

The lender or servicer managing the administration of the loan specifies one or more time intervals during, at, or by which it will evaluate whether the performance metrics, conditions, requirements, or other terms from Step 5 were successfully achieved. Said time intervals may include, but are not limited to, days, weeks, months, years, decades, or any other increment of time and may or may not specify the time until or between said evaluation(s) whether in the context of the present time or in the future.

7. Identify a Quantity of the Current Outstanding Loan Balance to Forgive if the Performance Metric(s) from Step 5 are Achieved

The lender or servicer managing the administration of the loan specifies a quantity of the current outstanding loan balance to forgive if the performance metric(s) from Step 5 are achieved by the borrower(s) as determined by the evaluation occurring in Step 8 at the time specified in Step 6. The quantity identified may be, but is not limited to, a percentage or dollar amount of: the outstanding current loan balance identified in Step 1; the current property value identified in Step 2; the negative equity identified in Step 3; or any other direct, derived, related, or unrelated quantity or any combination of the aforementioned quantities whether they be a portion, all, or more than the current negative equity embodied by the property at the time this method is applied. The quantity specified may or may not differ from quantities specified in the past use of this method or that may be specified in the future use of this method.

### 8. At the Time Interval(s) Specified in Step 6, Evaluate the Performance Metric(s) Identified in Step 5

At the time interval specified in Step 6, the lender or servicer managing the administration of the loan evaluates the metrics, conditions, requirements, or other terms from Step 5. Performed at the discretion of the lender or servicer managing the administration of the loan, the evaluation may include, but is not limited to, any assessment of: whether all or a portion of the metrics, conditions, requirements, or other terms from Step 5 were achieved or exceeded; the extent to which they were achieved or exceeded either individually or in aggregate; or any other combination thereof.

9. Identify Whether the Performance Metric(s) Identified in Step 5 were Successfully Achieved

Based on the performance evaluation from Step 8, if the lender or servicer managing the administration of the loan determines at its sole discretion that the metrics, conditions, requirements, or other terms from Step 5 were successfully achieved by the borrower(s), then the user of this method shall proceed to Step 10. If, at its sole discretion, the lender or servicer managing the administration of the loan determines that the metrics, conditions, requirements, or other terms were not successfully achieved, then this method terminates, as shown by the “End Method” flowchart terminator.

### 10. Forgive the Quantity of the Current Outstanding Loan Balance Identified in Step 7

The lender or servicer managing the administration of the loan reduces the current outstanding loan balance by the quantity of current outstanding loan balance identified in Step 7. At its sole discretion, the lender or servicer managing the administration of the loan determines how to apply said reduction which may include, but is not limited to, the reduction in whole or in part of: current unpaid principal balance; any accrued or delinquent loan interest or escrow monies or shortages; late fees; corporate advances or recoverable fees; prepaid monies expended by the lender or loan servicer for the benefit of the borrower(s); annual or account fees; non sufficient fund or returned fund fees; servicing or loan processing fees; pre-payment or other penalties; property inspection or valuation fees; third party fees from entities that may include, but are not limited to, attorneys, title companies, insurance companies, publication services, rating agencies; any other fees, expenses, or costs that are due from and owed by the borrower(s) to the lender or loan servicer managing the administration of the loan; the capitalization of any of the aforementioned items; or any combination thereof. Upon completion of Step 10, the user of this method shall return to the “Start Method” flowchart initiator to determine whether further use is warranted.

I claim:

1. A method, for modifying a loan against property that embodies negative equity by forgiving a quantity of outstanding monies due from and owed by one or more borrower(s), comprising:
Identifying a summation of outstanding monies due from and owed by one or more borrower(s) of a loan to the lender or loan servicer managing the administration of the loan;
Identifying the current value of the property against which the loan has been originated;
Identifying whether the current summation of monies due from and owed by the borrower(s) is greater than the current value of the property against which a loan has been originated;
Identifying whether there is mutual desire between the borrower(s) of the loan and the lender or loan servicer managing the administration of the loan to forgive a quantity of the current summation of outstanding monies due from and owed by the borrower(s);
Identifying one or more performance metrics, conditions, requirements, or other terms the borrower(s) must successfully achieve in exchange for forgiveness of an identified quantity of the current summation of outstanding monies due from and payable by the borrower(s);
Establishing one or more time interval(s) during, at, or by which the one or more performance metrics, conditions, requirements, or other terms the borrower(s) must successfully achieve in exchange for forgiveness of a quantity of the current summation of outstanding monies due from and payable by the borrower(s);
Evaluating whether the borrower(s) successfully achieved the performance metrics, conditions, requirements, or other terms within the established time interval(s);
Forgiving an identified quantity of the summation of outstanding monies due from and payable by the borrower(s) when the performance metrics, conditions, requirements, or other terms are successfully achieved by the borrower(s) of the loan within the prescribed time interval(s).

2. The method of claim 1 wherein a summation of outstanding monies due from and owed by the borrower(s) to the lender or loan servicer managing the administration of the loan is determined by the lender or loan servicer managing the administration of the loan.

3. The method of claim 1 wherein the current value of the property against which the loan has been originated is derived using a valuation technique that is acceptable to the lender or loan servicer managing the administration of the loan.

4. The method of claim 1 wherein the lender or loan servicer managing the administration of the loan determines whether the summation of outstanding monies due from and owed by the borrower(s) is greater than the current value of the property against which a loan has been originated.

5. The method of claim 1 wherein one or more performance metrics, conditions, requirements, or other terms are established by the lender or loan servicer managing the administration of the loan.

6. The method of claim 1 wherein one or more time interval(s) during, at, or by which the performance metrics, conditions, requirements, or other terms will be evaluated are determined by the lender or loan servicer managing the administration of the loan.

7. The method of claim 1 wherein the quantity of the current summation of outstanding monies due from and payable by the borrower(s) to be forgiven in exchange for the successful achievement by the borrower(s) of the performance metrics, conditions, requirements, or other terms is determined by the lender or loan servicer managing the administration of the loan.

8. The method of claim 1 wherein the successful achievement of the performance metrics, conditions, requirements, or other terms during, at, or by the established time interval(s) is determined by the lender or loan servicer managing the administration of the loan.

9. The method of claim 1 wherein the forgiveness of the quantity of the current summation of outstanding monies due from and payable by the borrower(s) is executed by the lender or loan servicer managing the administration of the loan.

10. The method of claim 1 wherein the lender or loan servicer managing the administration of the loan communicates the application of the method to the borrower(s) of the loan.

11. The method of claim 1 wherein the mutual desire among the borrower(s) of the loan and the lender or loan servicer managing the administration of the loan to forgive a quantity of the summation of outstanding monies due from and owed by the borrower(s) at the time the method is applied may or may not be derived from the prospect of the borrower(s)'s future success in achieving the performance metrics, conditions, requirements, or other terms.

12. The method of claim 1 wherein the origination and existence of the loan against the property predates the first application of the method.

13. The method of claim 1 wherein the lender or loan servicer managing the administration of the loan maintains an account assigned to the borrower(s) that includes at least an accounting of the current summation of outstanding monies due from and payable by the borrower(s) and a current valuation of the property against which the loan was originated.

14. The method of claim 9 wherein executing the forgiveness of a quantity of the current summation of outstanding monies due from and payable by the borrower(s) includes applying a budgeting rule to the account assigned to the borrower(s) that reduces the current summation of outstanding monies due from and payable by the borrower(s).

15. The method of claim 5 wherein the performance metrics, conditions, requirements, or other terms are quantifiable and measurable at one or more time intervals.

16. The method of claim 6 wherein the time interval is quantifiable and trackable.
